(19) United States
(12) Patent Application Publication
(10) Pub. No.: US 2008/0206703 A1
(43) Pub. Date: Aug. 28, 2008

(54) DENTAL VENEER INSTRUMENT

(75) Inventors: Irving A. Meeker, Pasadena, CA (US); Robert L. Ibsen, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: DEN-MAT CORPORATION, Santa Maria, CA (US)

(21) Appl. No.: 11/680,159

(22) Filed: Feb. 28, 2007

(51) Int. Cl. A61C 5/00

(52) U.S. Cl. 433/49

(57) ABSTRACT

A device adapted to facilitate retention and release of a dental laminate includes an elongated main body having a channel extending through it, a resilient element connected to a first end of the main body for contact with the dental laminate, a connector disposed at a second end of the main body adapted to communicate the channel with vacuum suction, and a particularly configured valve body. The valve body includes a passage defined therein that is selectively rotatable between increased and decreased alignments with the main body channel to permit variable fluid flow through the channel as well as to essentially cut off fluid flow through the channel when desired. A bearing assembly is also disposed between an extension of the connector and a proximal portion of the elongated main body, thereby permitting essentially stress-free rotational movement between the connector and the main body.

### BACKGROUND OF THE INVENTION

1. Field of the Invention

One treatment modality in dentistry involves placement of custom-made porcelain laminates onto tooth enamel for permanent bonding to teeth with resin cement. Such laminates are fabricated to replicate idealized tooth contours, and color designed to correct deficiencies in the appearance, shape, color, or angulation of existing teeth.

2. Description of Related Art

U.S. Pat. No. 4,822,278 to Oliva et al. discloses a dental instrument used for dental veneer placement and fixation having a valve port on a hand piece. The Oliva et al. instrument is vacuum operated, with the valve port being opened or closed using a fingertip or a movable valve member to provide controlled pick-up and release of a veneer.

U.S. Pat. No. 5,118,153 to Allison et al. relates to a vacuum operated pick including a handle and a bellows. Upon contact with a component to be picked up, vents defined in the handle are covered by a user's finger, thereby creating a vacuum within the bellows to draw the component into a protective shield.

U.S. Patent Application Publication 2003/0224321 A1 concerns a dental appliance usable to position dental veneers by way of grippers of various types.

### SUMMARY OF THE INVENTION

It is one object of the invention to provide an improved aspirator utilizing standard vacuum suction lines forming normal components of a dental unit in a typical dental operatory. A more specific object is to provide a comfortable, hand held pen-like object connected to standard suction tubing lines in order to delicately hold a fragile porcelain veneer, by suction, and transfer the veneer safely and without stress to the tooth of a patient for cementation.

According to one feature of the invention, upon delivery of a veneer to the tooth, suction is cut off in order to disengage the veneer from the aspirator by way of a minor movement of the operator's index finger. A primary purpose in providing this feature is to eliminate typical operator stress relating to the security and delicacy of the porcelain and suction cup attachment.

One device according to the invention includes an elongated main body having a channel extending through it, a resilient element connected to a first end of the main body for contact with a dental laminate, a connector disposed at a second end of the main body adapted to communicate the channel with vacuum suction, and a particularly configured valve body. The valve body, in this configuration, includes a passage defined therein that is selectively rotatable between increased and decreased alignments with the main body channel to permit variable fluid flow through the channel as well as to essentially cut off fluid flow through the channel when desired.

Pin and recess structure can be provided between the main and valve bodies to limit valve body rotational movement. The valve body preferably has a disc disposed thereon permitting variations in fluid flow through the channel to be simply governed by movement of a user's finger, and, optimally, is manually insertable into and removable from a bore in the main body that intersects the channel. Markings can be included on the disc, the main body, or both the disc and the main body to provides a visual indication of a valve body on/off status.

Certain features of the invention also relate to a bearing assembly disposed between an extension of the connector and a proximal portion of the elongated main body permitting essentially stress-free rotational movement between the connector and the main body. The bearing assembly can be at least partially defined by an approximately cylindrical extension of the connector, and can also include a ring secured to the main body and surrounding the extension.

Other aspects of the invention relate to a process of handling a dental laminate in which the dental laminate is contacted with the resilient element while applying a negative pressure in the main body channel, and the valve body is rotated to variably align the passage defined in the valve body with the channel to adjust the negative pressure.

By way of features such as those referred to, the ability to essentially simultaneously place multiple laminates is enhanced. Conventionally, during cementation, a dental assistant had to load the laminate with cement and hand the veneer to the doctor with standard cotton pliers. Such a process typically involved difficulties relating to grasping the pliers with the correct amount of force; if too much force was used, the veneer could fracture, while if too little force was used, the veneer could drop. Transferring a veneer successfully to a doctor's grasp several times over was often accompanied by stress, peril, and uncertainty. This invention eliminates concerns about successful and safe transfer of veneers from the assistant to the doctor and ultimately to the tooth.

One particularly advantageous feature of the invention relates to a ball bearing 360° swivel that essentially eliminates torsional resistive forces that would otherwise be transferred from the suction tubing to the operator's hand, thereby hampering tactility during the delicate veneer placement procedure.

The veneer can be safely held when conditioning the porcelain surface for bonding. Laminates can be efficiently transferred to a patient's teeth for initial fittings and then quickly and efficiently removed from the tooth to initiate the bonding process.

The bellowed suction cup used to hold the veneer is also advantageous; this bellowed cup may be formed of soft silicone. A soft silicone cup tends to resist minor dislodging forces, such as accidental impacts or forces imposed by a stream of forced air from a dental air syringe used to dry and thin resinous materials placed on the veneer for bonding purposes, by deflection and bending of the suction cup, and helps to avoid dislodgement of the veneer resulting from a rigid suction cup attachment. A bellowed suction cup is ideal for additionally serving to apply a cushioned and even force against the veneer for gentle seating onto the tooth.

An aspirator according to the invention can advantageously be formed primarily of tubular shaped, anodized aluminum, incorporating a one-piece rotary valve featuring a finger operated disc for operation of the cut-off function. All components are designed for repeated steam autoclaving for long service life, although suction cups used in conjunction with the aspirator are designed to be discarded and replaced after each use.

Certain features of the invention are new and provide new results. These features include the design and construction of the invention, which maximize available suction by maximizing diameters within the device at all points, ergonomic design, a ball bearing 360° swivel for true stress free rotation, a bellowed suction cup design, and a finger operated rotary disc valve providing low profile, aseptic control for both left and right handed users. A direction arrow gives the operator visual indication of the on/off status of the valve.

A process of handling a dental laminate is also described.

Other objects, features, and advantages of the invention will be apparent from the present description, the claims, and the drawing figures.

### BRIEF DESCRIPTION OF THE DRAWINGS

FIG. 1 is an exploded view showing various components of one embodiment of an aspirator according to the invention.

FIG. 2 is a side view of an elongated main body forming one component of the aspirator shown in FIG. 1.

FIG. 3 is a top view of the body illustrated in FIG. 2.

FIG. 4 is a sectional view of the body as seen along line IV-IV of FIG. 3.

FIG. 5 is a sectional view of the body as seen along line V-V of FIG. 2.

FIG. 6 is a side view of a valve body receivable in a bore provided in the main body.

FIG. 7 is a sectional view of the valve body as seen along line VII-VII of FIG. 6.

FIG. 8 is a sectional view of the valve body as seen along line VIII-VIII of FIG. 6.

FIG. 9 is a view of a connector used to secure the aspirator of the invention to a vacuum suction line.

FIG. 10 is a sectional view of a nozzle or nose adapted to receive a disposable resilient tip designed to contact a dental veneer.

FIG. 11 is a top view of an aspirator according to the invention after assembly.

FIG. 12 is a sectional view of the assembled aspirator as seen along line XII-XII of FIG. 11.

FIG. 13 is a sectional view of a commercially available elastomeric element appropriate for use as the resilient tip used to contact the dental veneer.

### DETAILED DESCRIPTION OF THE INVENTION

The manner in which various components of an aspirator 20 according to this invention cooperate is illustrated in the exploded view provided by FIG. 1. The aspirator 20 shown includes an elongated main body 22, a proximal end connector 24, a nose or nozzle 26, a pin 28, a valve body 30 having an actuation disc 31, and an outer bearing ring 32. The function and operation of each of these components is described below.

One ergonomically configured outer contour of the elongated main body 22 is shown in the side view of FIG. 2. The body 22 can be machined or cast to include a front or distal diametrical expansion 34 and a rear or proximal diametrical expansion 36 which facilitate gripping of the body 22 by a user. In one preferred embodiment of the invention, the body 22 is composed of 6061 aluminum. When used, the body 22 is preferably gripped like a toothbrush, for example, so that a user's index finger conveniently engages both the actuation disc 31 and the front expansion 34. Rotational movement can easily be imparted to the actuation disc 31 by movement of the tip of the user's index finger along or with respect to the outer surface of the front expansion 34 while pressing against the outer edge of the actuation disc 31. Of course, if the user prefers, the body 22 could alternatively be gripped in the manner of a pen or pencil, with the front expansion 34 contacted by a user's thumb, index finger, and middle finger, and the rear expansion 36 contacted by the outer part of the user's hand located between the index finger and thumb. A portion of the body 22 is absent or is removed from the front expansion so that, viewed from the side, a notch, kerf, or similar structure 38, described below, remains or is produced at what will be referred to as the “top” side of the body. The structure 38 will be referred to as a notch in the following description for simplicity.

The view of the top side of the body 22 provided by FIG. 3 shows the configuration of the notch 38, which includes a flat top surface 40. The surface 40 extends circumferentially around the opening of a stepped or grooved valve receiving bore 42, configured and dimensioned to receive the valve body 30 in a manner to be described. A portion of the flat top surface 40 is provided with a circumferentially extending recess 44, defining an arc which may be 30°-45°, for example, but which could be of any desired but appropriate radial extent. The recess extends into the body 22 in a direction substantially parallel to the center axis of the bore 42.

The sectional view of the body 22 provided by FIG. 4 shows the stepped or grooved bore configuration. The bore 42 has larger diameter recesses or grooves 46, designed to receive o-ring seals mounted on the valve body 30, separating smaller diameter sections 48 that fit closely, with a small clearance, around a stem or shaft of the valve body 30. FIG. 4 also shows the manner in which the recess 44 extends from the top surface 40 into and terminates within the body 22.

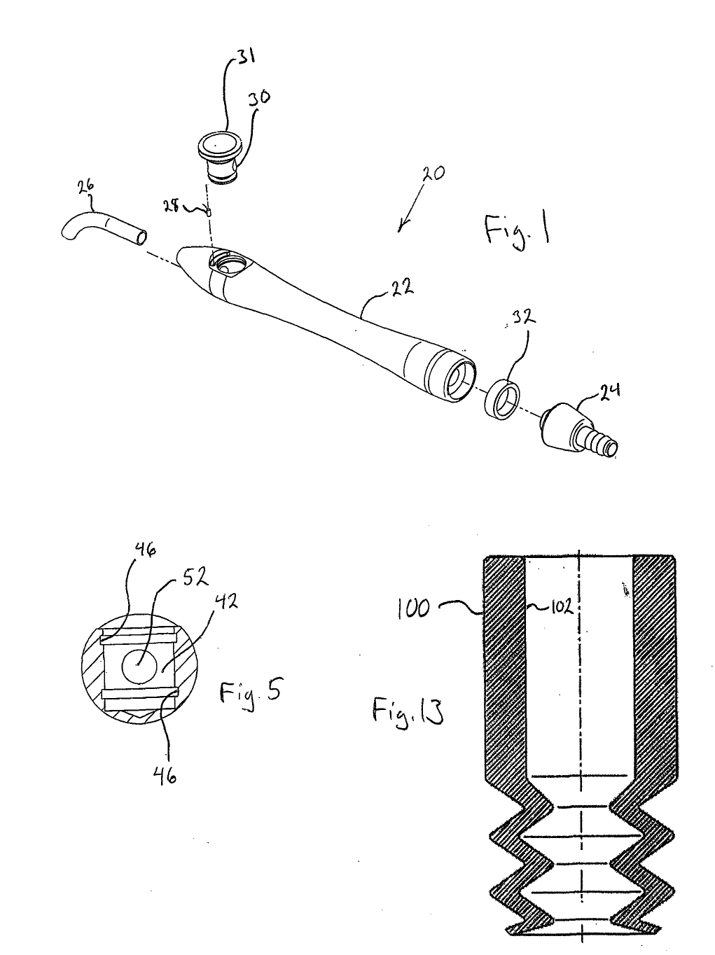

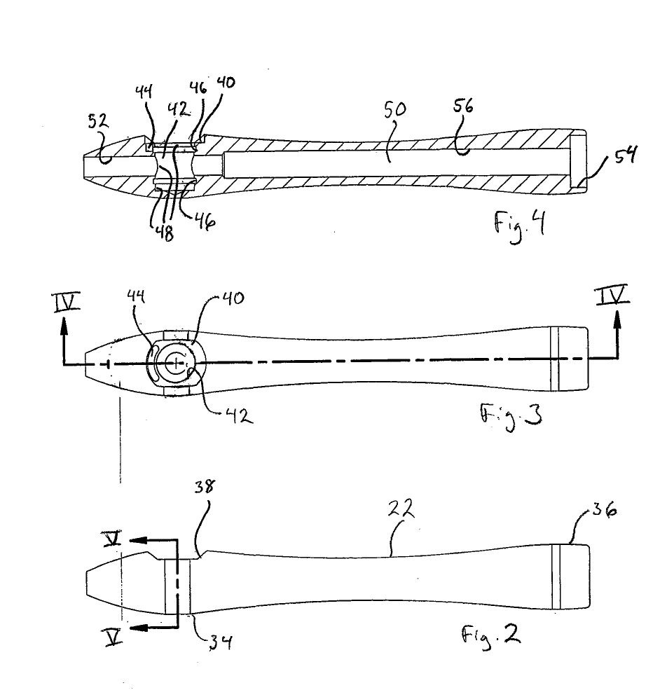

A longitudinally extending fluid transmission orifice, bore, or channel 50, referred to below as a channel for simplicity, is formed in the body 22 and intersects the valve receiving bore 42 as shown in FIG. 4. The channel 50 may have a stepped or grooved configuration, and, as illustrated, includes a first, distal section 52 dimensioned to receive the nose or nozzle 26, a second, proximal section 54 dimensioned to receive components of a ball bearing or similar structure to be described, and a third, intermediate section 56 interconnecting the distal and proximal bore sections 52 and 54. A position of intersection between the distal section 52 of the channel 50 and the bore 42 according to one embodiment of the invention is evident from FIG. 5. The recesses or grooves 46 in the valve receiving bore 42 are also indicated in FIG. 5.

FIG. 6 is a side view of the valve body 30 that is to be received for limited rotation within the bore 42 of the elongated main aspirator body 22. The valve body 30 includes a cylindrical stem 60 having recesses or grooves 62 machined or formed therein that align with the recesses or grooves 46 provided in the valve receiving bore 42. Elastic O-rings or other seals 65, shown in FIG. 11, are to be received in the aligned recesses or grooves 46 and 62. FIG. 6 also shows the actuation disc 31 located at the top end of the valve body 30.

A passage 64 extends through an appropriate portion of the stem 60. When the valve body 30 is mounted in the valve receiving bore 42, the passage 64 can be selectively aligned, partially or completely, with the channel 50 to permit variable fluid flow through the channel 50. The passage 64 can also be rotated out of alignment with the channel 50 to essentially cut off fluid flow through the channel 50.

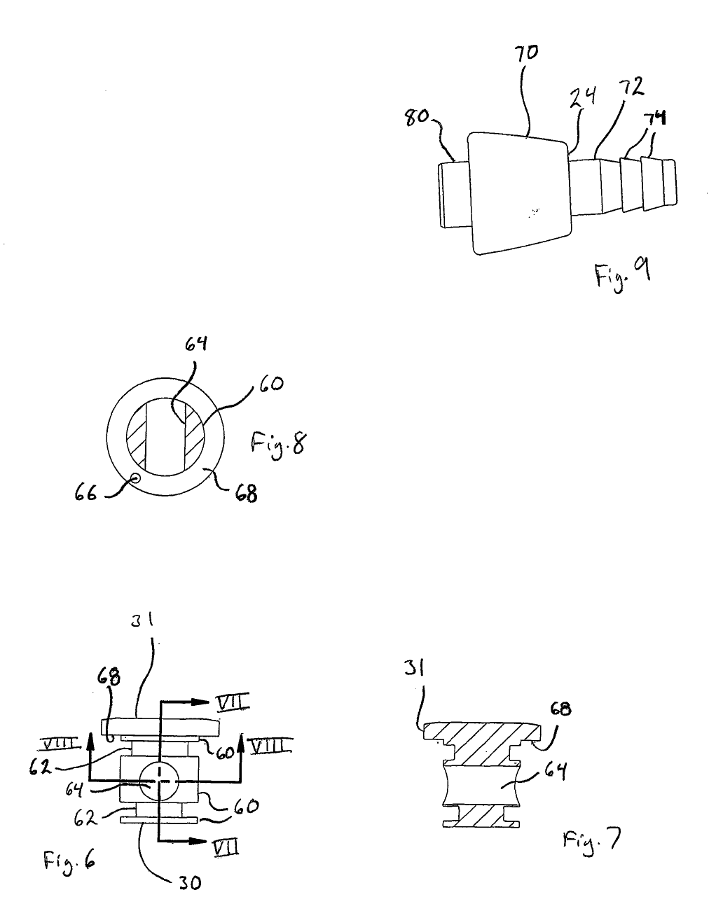

The sectional views provided by FIGS. 7 and 8 show the manner in which the passage 64 extends diametrically through the stem 60 of the valve body. FIG. 8 also illustrates a cylindrical or other appropriate bore 66, defined in an underside 68 of the actuation disc 31, that is adapted to receive the pin 28. As shown in FIG. 8, the bore 66 is offset to one side of the passage 64. The cross sectional shape and exact dimensions of the bore 66 depend, of course, on the cross sectional shape and dimensions of the pin 28, which may be secured within the recess 66 by press fitting or in any other appropriate manner.

To secure the valve body 30 to the main body 22, the pin 28 attached to the actuation disc 31 is aligned with the recess 44. The stem 60 of the valve body 30, with O-rings 65 mounted in the recesses or grooves 62, is then pushed or otherwise inserted into the bore 42. Insertion continues until the O-rings 65 snap into the recesses or grooves 46 and the underside 68 of the actuation disc 31 abuts against the flat surface 40. After the stem 60 of the valve body is properly positioned within the bore 42 in this way, the pin 28 will abut against ends of the recess 44 provided in the flat surface 40 of the notch 38 to limit rotational movement of the actuation disc to the particular arc delimited by the recess 44. The particular configuration of the valve 30 and the actuation disc 31 cooperate to produce a finger operated rotary disc valve having a low profile that permits aseptic control for both left and right handed users. Removal of the stem 60 from the bore 42 can be performed by contacting the underside 68 of the disc, for example with fingernails, and popping the stem 60 out of the bore.

The proximal end connector 24 illustrated in FIG. 9 has a body portion 70, which is tapered so as to be visually appealing. A cylindrical extension 72 having ridges 74 defined on its outer circumference extends rearward from the body portion. A conventional vacuum suction line, through with fluids from the mouth of a patient are removed, fits over the extension 72. The vacuum suction line is typically formed of fluid tight, elastomeric material, and frictional retention of the suction line in proper position over the extension 72 is facilitated by the ridges 74. Another extension 80 is defined at a forward end of the body portion 70. The extension 80 is roughly cylindrical and constitutes an inner bearing ring cooperating with the outer cylindrical ring 32 and bearing elements (not shown) to provide the aspirator 20 with a pivotal end structure defining a bearing assembly once the aspirator is assembled. Both the valve body 30 and the proximal end connector 24 can be made of the same material as the elongated main body 22, such as 6061 aluminum.

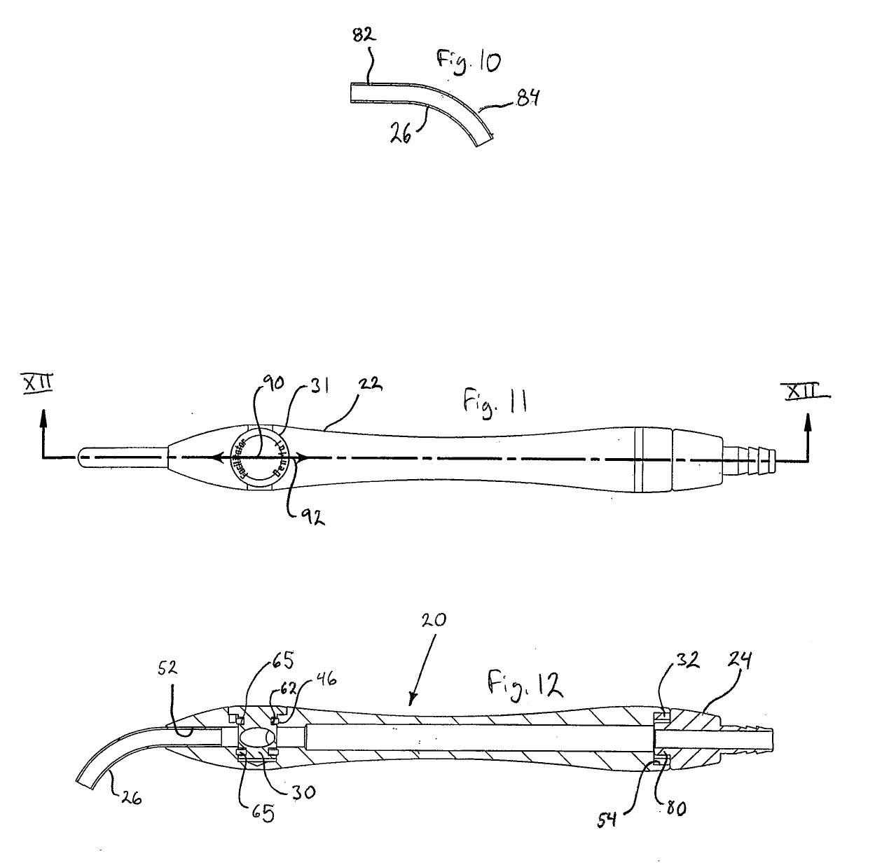

The nose 26 shown in FIG. 10 includes a straight section 82, adapted to be press fit or otherwise secured within part of the distal section 52 of the channel 50, and a curved section 84, adapted to receive a disposable, deformable elastomeric suction cup or tip (not illustrated in FIG. 10) used to contact the dental veneer. In one embodiment of the invention, the nose 26 is composed of 3/16 inch outer diameter 304 stainless steel pipe having a 0.02 inch wall thickness.

FIGS. 11 and 12 show the aspirator 20 following assembly of its components. Referring initially to the proximal end of the aspirator illustrated in the sectional view provided by FIG. 12, after assembly, both the outer bearing ring 32 and the inner bearing ring formed by the extension 80 of the proximal end connector 24 are received within the proximal bore section 54. The outer bearing ring is press fit or otherwise secured within the bore section 54, and bearing elements such as balls, cylinders, etc. (not shown) are received in races defined in the ring 32 and the extension 80. The bearing elements are thus interposed between the inner circumferential surface of the outer bearing race 32 and the outer circumferential surface of the extension 80, and permit a 360° swivel for true stress free rotation. The nose 26 is received as shown in the distal channel section 52, and the valve body 30 is mounted in the bore 42 with the O-rings 65 located in the aligned recesses or grooves 46 and 62.

As shown in the view of the top of the aspirator provided by FIG. 11, the top of the actuation disc 31 may be inscribed or otherwise provided with a direction-indicating line or arrow 90. This line or arrow can be aligned with a corresponding marking or corresponding markings 92 on the barrel formed by the main body 22 to give an operator a visual indication of the on/off status of the valve.

In one preferred way of using the aspirator, with the line or arrow 90 at 12 o'clock, a veneer for the upper jaw of a patient is placed on the suction cup so that the gingival aspect of the veneer points at 9 o'clock for right-handed users and 3 o'clock for left handed users. For the lower jaw, 3 o'clock is appropriate for right-handed users, while 9 o'clock is appropriate for left-handed users.

FIG. 13 is a sectional view of a bellowed suction cup 100 that may be used to hold the dental veneer. The suction cup 100 has a base portion, with a cylindrical inner bore 102 adapted to be received over the end of the curved section 84 of the nose 26, and a bellowed section extending from the base portion. The suction cup 100 is commercially available, may be formed of soft silicone, and resists minor dislodging forces produced by accidental impacts or a stream of forced air from a dental air syringe used to dry and thin resinous materials placed on the veneer for bonding purposes, since such forces result in deflection and bending of the suction cup rather than the dislodgement of the veneer that would likely result from a rigid suction cup attachment. The bellowed suction cup referred to is ideal for applying a cushioned and even force against the veneer for gentle seating onto the tooth.

The foregoing disclosure has been set forth merely to illustrate the invention and is not intended to be limiting. Since modifications to the disclosed embodiments incorporating the spirit and substance of the invention may occur to persons of ordinary skill in the art, the invention should be construed to include everything within the scope of the appended claims and equivalents thereof.

1. A device adapted to facilitate retention and release of a dental laminate comprising:
an elongated main body having a channel extending therethrough,
a resilient element connected to a first end of the main body for contact with the laminate,
a connector disposed at a second end of the main body adapted to communicate the channel with vacuum suction, and
a valve body including a passage defined therein that is selectively rotatable between increased and decreased alignments with the channel to permit variable fluid flow through the channel as well as to essentially cut off fluid flow through the channel when desired.

2. The device of claim 1, further comprising structure limiting rotational movement of the valve body.

3. The device of claim 2, wherein said structure includes a pin receivable in a recess including ends limiting said rotational movement.

4. The device of claim 3, wherein the pin is secured to the valve body and the recess is defined in said main body.

5. The device of claim 1, wherein the valve body has a disc disposed thereon that permits variations in said fluid flow through the channel by movement of a user's finger.

6. The device of claim 1, wherein the valve body is manually insertable into and removable from a bore in said main body that intersects the channel.

7. The device of claim 5, wherein at least one of said disc and said main body provides a visual indication of a valve body on/off status.

8. The device of claim 7, wherein the disc and the main body include markings providing said visual indication.

9. A device adapted to facilitate retention and release of a dental laminate comprising:
an elongated main body having a channel extending therethrough,
a resilient element connected to a first end of the main body for contact with the laminate,
a connector disposed at a second end of the main body adapted to communicate the channel with vacuum suction,
a valve body that permits variable fluid flow through the channel as well as essential cut off of fluid flow through the channel, and
a bearing assembly disposed between an extension of the connector and a proximal portion of the elongated main body permitting essentially stress-free rotational movement between the connector and the main body.

10. The device of claim 9, wherein the bearing assembly is at least partially defined by the connector.

11. The device of claim 10, wherein the bearing assembly includes a ring secured to the main body and surrounding an approximately cylindrical extension of the connector.

12. The device of claim 9, wherein the valve body has a disc disposed thereon that permits variations in said fluid flow through the channel by movement of a user's finger.

13. The device of claim 9, wherein the valve body is manually insertable into and removable from a bore in said main body that intersects the channel.

14. The device of claim 12, wherein at least one of said disc and said main body provides a visual indication of a valve body on/off status.

15. The device of claim 9, wherein the valve body is rotatable.

16. The device of claim 15, further comprising structure limiting rotational movement of the valve body.

17. The device of claim 16, wherein said structure includes a pin receivable in a recess including ends limiting said rotational movement.

18. The device of claim 17, wherein the pin is secured to the valve body and the recess is defined in said main body.

19. A process of handling a dental laminate comprising:
contacting the dental laminate with a resilient element connected to an end of an elongated main body and having a channel extending therethrough while applying a negative pressure in the channel, and
rotating a valve body so that a passage defined in the valve body is variably aligned with the channel to adjust the negative pressure.

20. The process of claim 19, further comprising limiting rotation of the valve body to a predetermined interval.

21. A process of handling a dental laminate comprising:
contacting the dental laminate with a resilient element connected to an end of an elongated main body and having a channel extending therethrough while applying a negative pressure in the channel, and
rotating a valve body so as to physically transect the channel, cut off the negative pressure, and permit release of the dental laminate from contact with the resilient element.
